(19) United States
(12) Patent Application Publication
(10) Pub. No.: US 2015/0098553 A1
(43) Pub. Date: Apr. 9, 2015

(54) System And Method For Providing Alerts

(71) Applicant: David F. Bonitati, Sylvania, OH (US)

(72) Inventor: David F. Bonitati, Sylvania, OH (US)

(21) Appl. No.: 14/508,847

(22) Filed: Oct. 7, 2014

Related U.S. Application Data
(60) Provisional application No. 61/887,501, filed on Oct. 7, 2013.

(51) Int. Cl. H04M 3/51

(52) U.S. Cl. CPC H04M 3/5116
USPC 379/45

(57) ABSTRACT

A method and system for generating real-time or near real-time alerts is disclosed, the method and system related to emergency events. Particularly, the method and system generate alerts to a user that may be filtered based on a type of emergency event, such as a crime-based event or a fire-based event, and/or a location of the emergency event, such as an event within a desired geographic radius.

### CROSS-REFERENCE TO RELATED APPLICATIONS

This application claims the benefit of U.S. Provisional Application No. 61/887,501, filed Oct. 7, 2013, the disclosure of which is incorporated herein by reference.

### FIELD OF THE INVENTION

The invention is related to a system and method for providing alerts to a user, and more specifically to a system and method for providing alerts to a user based on a location of an emergency event and a location of a monitored location.

### BACKGROUND OF THE INVENTION

A variety of systems exist today to allow persons to summon help, or otherwise raise an alarm. For example, home-based alarm systems often include a “panic button” which the homeowner can press to set off the alarm siren and/or to summon help, via the 9-1-1 emergency phone number, from the police, fire, or medical departments. The 9-1-1 emergency phone number may also be accessed by typical means, such as via a landline telephone, a cellular phone, or another smart phone or communication device. When an emergency phone call is received via the 9-1-1 emergency phone number, a dispatcher typically enters information related to the emergency into a Computer Aided Dispatch (CAD) system. The entered information may be related to a location of the emergency event, such as an address, and may include information regarding the type of the emergency (e.g., a crime-based emergency, a fire-based emergency, or a medical-based emergency). The CAD system then dispatches the appropriate emergency responder to the location of the emergency event.

However, the CAD system only notifies emergency responders and does not notify others in a vicinity of the emergency event of the emergency. For example, homeowners may wish to know of a recent 01′ on-going burglary near their home 01′ business, or that a nearby home 01′ business is on fire. For a homeowner to learn of a nearby emergency, a police scanner, fire station scanner, and the like may be monitored. However, scanners would transmit information regarding all emergency events to a homeowner, and not just those events in a vicinity of a homeowner or business owner. Furthermore, such scanners may also transmit information regarding non-emergency events.

Certain monitoring services, such as the service provided under the CRIMEMAPPING trademark by The Omega Group (see www.crimemapping.com), offer a monitoring service that provides alerts regarding criminal activity. However, monitoring services such as the CRIMEMAPPING service are based on police reports that are filed within a database, and not based on emergency calls to the 9-1-1 telephone number. Accordingly, such monitoring services have numerous limitations, including, but not limited to: the monitoring services provide alerts based only on crime-based emergencies (and not other emergencies); not all emergencies result in police reports being filed; and before the monitoring service will be triggered to send an alert, the police report must be logged into a database, thereby delaying an alert from being generated until hours or even days after an emergency event has occurred.

Accordingly, a method and system for generating real-time or near real-time alerts related to emergency events, particularly alerts that may be filtered based on a type of emergency event and/or a location of the emergency event would be desirable.

### SUMMARY OF THE INVENTION

A method and system for generating real-time or near real-time alerts related to emergency events, particularly alerts that may be filtered based on a type of emergency event and/or a location of the emergency event is described in detail in the following disclosure.

In an embodiment of the invention, a method and system of generating real-time or near real-time alerts related to emergency events as disclosed herein.

In another embodiment of the invention, a system for generating alerts comprises a computer aided dispatch (CAD) system for receiving information related to an emergency event provided through the 9-1-1 emergency telephone number; a receiver in communication with the CAD system via a network for receiving information related to the emergency event from the CAD system; a user device in communication with the receiver via a network for selectively receiving an alert related to the emergency event from the receiver, wherein the alert is selectively transmitted based upon at least one of a type of the emergency event and a location of the emergency event.

In another embodiment of the invention, a method of selectively generating an alert based on an emergency event comprises the steps of providing a computer for receiving information associated with a location of an emergency event; providing a second location to which the location of an emergency event is to be compared; providing a desired geographic radius around the second location inside of which alerts should be generated if an emergency event occurs; converting the second location from a street address to longitude and latitude coordinates using the computer; converting the longitude and latitude coordinates to radians using the law of cosines using the computer; comparing the location of the emergency event to the second location converted into radians to determine whether the emergency event occurred within the desired geographic radius of the second location with the computer; and transmitting an alert from the computer to a user device if the emergency event occurred within the desired geographic radius.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the invention, will become readily apparent to those skilled in the art from the following detailed description of a preferred embodiment when considered in the light of the accompanying drawings in which:

FIG. 1 is a schematic diagram of a system for providing alerts regarding an emergency event according to an embodiment of the invention.

FIG. 2 is a schematic diagram of a process for determining whether an alert will be transmitted from a receiver of the system of FIG. 1 according to another embodiment of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

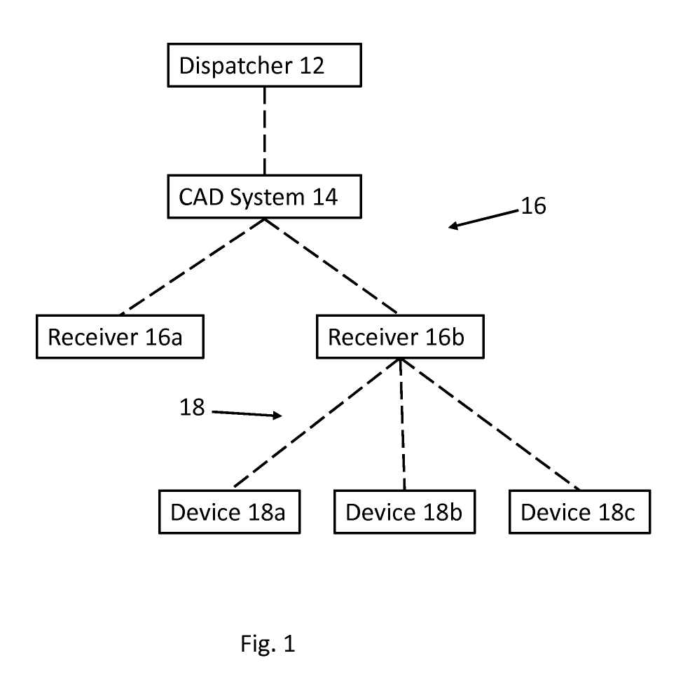

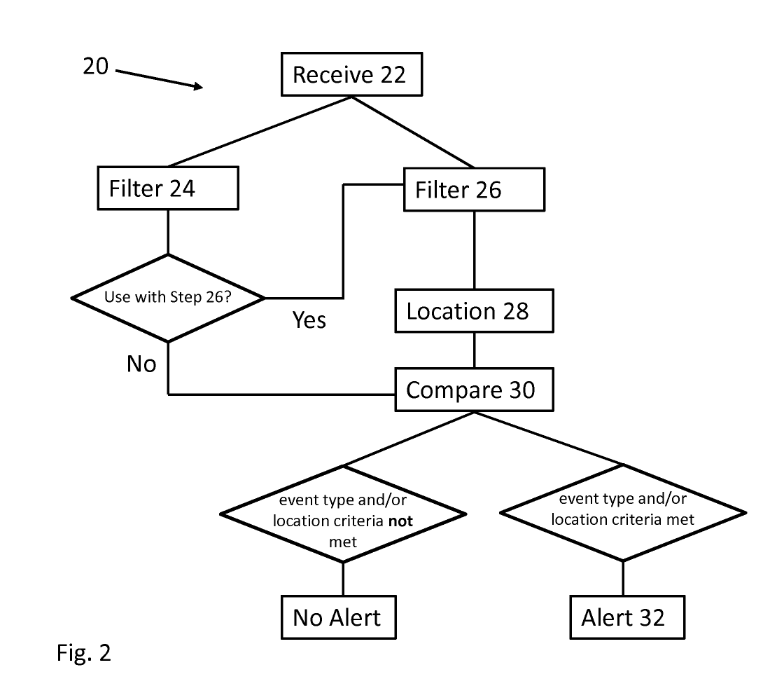

FIGS. 1 and 2 illustrate system and method for providing alerts according to the present invention. The system 10 includes a Computer Aided Dispatch (CAD) system 14, a receiver 16, and a user device 18. The CAD system 14 is a computer or other device utilized by a police dispatcher 12 in receipt of an emergency phone call through the 9-1-1 emergency telephone number. Calls to the 9-1-1 emergency telephone number are received by a dispatcher 12 who categorizes the call as a nonemergency call or an emergency call. If the dispatcher 12 determines that the call is an emergency call, the emergency call is classified as a fire-based emergency, a crime based emergency, and/or a medical-based emergency.

Once emergency calls are categorized and entered in the CAD system 14 by the dispatcher 12, dispatching requests and/or instructions are transmitted from the CAD system 14, through a network, to one or more receiver 16. The network may be a computer network (e.g., the internet, a cloud computing network, and the like), a phone network, or any network capable of transmitting data from one location to another. For example, the receiver 16 may be a phone system 16a or other communication device used by a policeman, fireman, EMT, or the like that will respond the appropriate emergency call based on how the call is categorized by the dispatcher 12. The receiver 16 may also be a transmitting computer 16b adapted to receive information regarding the categorized emergency call, such as the type of emergency, location of the emergency, or another parameter provided by the dispatcher 12 to the CAD system 14.

The data received by the transmitting computer 16b regarding an emergency call is then transmitted by a network as an alert to the user device 18 or to a plurality of user devices 18. The network may be a computer network (e.g., the internet, a cloud computing network, and the like), a phone network, or any network capable of transmitting data from one location to another. The user device 18 may be a smart phone 18a, a tablet computer 18b, a landline telephone 18c, or any other device adapted to receive data via the network. The alert may be a text message, an email, a pre-recorded voicemail, or a push notification to a smart device such as an iPhone, iPad, Droid, Windows Phone, Blackberry, or the like. As explained in more detail below, the transmitting computer 16b (or any receiver 16) may conduct a process 20 to ensure that the information regarding the emergency phone call received by the dispatcher 12 is processed, a filtered, or otherwise classified and transmitted as the alert to a desired user device(s) 18 based on certain parameters set by a user of the user device(s) 18. For example, information regarding the emergency phone call may be transmitted to the user device(s) 18 only if it is: a certain type of emergency (e.g., a crime-based emergency, a fire-based emergency, a medical-based emergency, and the like), within a certain geographic area in respect of a particular address or addresses provided by the user of the user device(s) 18, and/or within a certain geographic area in respect of a current location of a user device(s) 18. For example, the receiver 16 may transmit an alert to the user of the user device(s) 18 if an emergency event occurs within a desired a desired geographic radius of a location input by the user. For example, the desired geographic radius may be a Yz mile radius of the addressees) to be monitored, within a 1 mile radius of the addressees) to be monitored, or within any desired distance of the address(es) to be monitored. Due the speed at which data may be transmitted through computer networks, alerts may be received in real-time or very near real-time upon the entry of information by the dispatcher 12 into the CAD system 14. Accordingly, the user is quickly made aware of an emergency event in proximity to a location that is monitored using the system 10, and appropriate preparations, monitoring, or assistance may be made by the user, as desired.

According to another embodiment of the invention shown in FIG. 2, the transmitting computer 16b (or any receiver 16) conducts the method 20 using a processor or other computing means in the receiver 16. As discussed herein, the process may include steps to process, filter, or otherwise classify information related to an emergency phone call received by the dispatcher 12 and entered into or otherwise transmitted to the CAD system 14. For example, information regarding the emergency phone call is received by the receiver 16b in a step 22. In another step 24, the information is then filtered based on a type of emergency (e.g., a crime-based emergency, a fire-based emergency, and the like). In another step 26, the information may also be filtered by the address from which the emergency originated as compared to the address desired to be monitored by the user so that the user receives an alert based on the location of the emergency event being within a particular radius. The receiver 16b may also conduct other processing, filtering, or other classifying actions. Furthermore, both of steps 24 and 26 and any other steps may be used together to filter the information, as desired.

In a step 28, a location of the addressees) to be monitored provided by the users and input into or accessed by the receiver 16b is converted to radians for a comparison to the location of the emergency event. The monitored address(es) are converted from a street address to longitude and latitude coordinates, and then to radians using the law of cosines. In a step 30, the result of step 28 is compared to the location of the emergency event to determine whether the emergency event occurred within a desired geographic radius of the monitored addressees). As noted above, the desired geographic radius of the monitored addressees) may be any distance desired. If the location of the emergency event occurred within the desired geographic radius as determined in step 30, an alert is transmitted from the receiver 16b to the user device 18 in a step 32. If the location of the emergency did not occur within the desired geographic radius, no alert is transmitted to the user device 18. In the event that the process 20 is not making a location determination and is instead making only an event type determination via step 24, a comparison is made of the event type to the desired event type for the purpose of providing an alert in step 30.

To reduce a number of records necessary for comparison using the process 20 when an emergency call is received, a distance in degrees based on the location of an emergency event may be compared to a distance in degrees based on a desired location to be monitored. Comparing locations based on a distance in degrees allows an expedited processing of the data in the step 30, thereby reducing a processing time by the computer and facilitating an expedited determination of whether an alert should be transmitted in the step 32.

In another embodiment of the invention, an application is downloaded onto the smart phone 18a of a user, and alerts may be pushed to the smart phone 18a. It is understood that any mobile computing user device 18 capable of receiving data may be used by the user to receive pushed alerts. Alerts pushed to the smart phone 18a may be based on the proximity of the smart phone 18a to an emergency event. That is, the GPS coordinates of the smart phone 18a are used in the process 20 in a similar fashion as described herein with respect to the monitored addressees). Accordingly, a push alert would be sent to the smart phone 18a of the user if the user is within a certain, pre-determined (or pre-submitted) radius of emergency events.

The invention also can include the function of a home security system integration that not only alerts the security monitoring center as per the currently available home security monitoring services, but also sends a notification to the transmitting computer 16b so all subscribers are notified immediately when the alarm goes off and without the delay. The current call center monitoring procedure includes a phone call to a main contact and second contact to confirm it is not a false alarm. After attempting to make those contacts, the call center than calls 911. In the system according to the invention, the transmitting computer 16b is immediately notified when the alarm goes off without the delay of waiting for the 911 call to be placed by the call center. This expedites subscriber awareness through the user devices 18 immediately after the alarm goes off without delay of waiting for a 911 call to be placed.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method and system of generating real-time or near real-time alerts related to emergency events as disclosed herein.

2. A system for generating alerts comprising:
a computer aided dispatch (CAD) system for receiving information related to an emergency event provided through the 9-1-1 emergency telephone number;
a receiver in communication with the CAD system via a network for receiving information related to the emergency event from the CAD system; and
a user device in communication with the receiver via a network for selectively receiving an alert related to the emergency event from the receiver, wherein the alert is selectively transmitted based upon at least one of a type of the emergency event and a location of the emergency event.

3. A method of selectively generating an alert based on an emergency event comprising the steps of:
providing a computer for receiving information associated with a location of an emergency event;
providing a second location to which the location of an emergency event is to be compared;
providing a desired geographic radius around the second location inside of which alerts should be generated if an emergency event occurs;
converting the second location from a street address to longitude and latitude coordinates using the computer;
converting the longitude and latitude coordinates to radians using the law of cosines using the computer;
comparing the location of the emergency event to the second location converted into radians to determine whether the emergency event occurred within the desired geographic radius of the second location with the computer; and
transmitting an alert from the computer to a user device if the emergency event occurred within the desired geographic radius.
